(19) United States
(12) Patent Application Publication
(10) Pub. No.: US 2014/0101105 A1
(43) Pub. Date: Apr. 10, 2014

(54) METHOD AND APPARATUS FOR DATA MIGRATION FROM HIERARCHICAL DATABASE OF MAINFRAME SYSTEM TO REHOSTING SOLUTION DATABASE OF OPEN SYSTEM

(71) Applicant: TIBERO CO., LTD., Gyeonggi-do (KR)

(72) Inventor: Hack Sung LEE, Gyeonggi-do (KR)

(73) Assignee: TIBERO CO., LTD., Gyeonggi-do (KR)

(21) Appl. No.: 13/660,140

(22) Filed: Oct. 25, 2012

(30) Foreign Application Priority Data
Oct. 10, 2012 (KR) 10-2012-0112506

(51) Int. Cl. G06F 7/00; G06F 17/30

(52) U.S. Cl. 707/635; 707/E17.005; 707/E17.044

(57) ABSTRACT

An apparatus performs a data migration from a database of a mainframe system to a rehosting solution database of an open system. An unload data set conversion module converts an unload data set, unloaded from the database of the mainframe system, into load files having standard format. A schema information generation module generates a schema information file having conversion rules by segment and field necessary for code system conversion of segment data in the load files having standard format. A code system conversion module converts the load files into load files having a code system of the open system pursuant to the schema information file, wherein the load files. A data load module sequentially reads segment data in the code-converted load files to load the segment data into the rehosting solution database.

### FIELD OF THE INVENTION

The present invention relates to data migration of a hierarchical database, and more particularly, to a data migration method and apparatus that load data of a hierarchical database, managed by a mainframe system, into a rehosting solution hierarchical database of an open system.

### BACKGROUND OF THE INVENTION

In the 1960s and 1970s, the government, the financial institution, and major companies much introduced a mainframe system for processing various data necessary for business activities. The mainframe system is a general-purpose mainframe computer that performs various operations by using a centralized management scheme in which a plurality of terminals is connected to one computer. For example, the System/360 available from IBM Corporation may be one of the mainframe systems. Since then, for approximately 30 years, the mainframe system led the computing industry of companies and continuously grew. However, a distributed environment in an open system such as the UNIX platform was beginning to be introduced in the late 1980 years, and downsizing into an open system for saving the operation and maintenance cost of a system was rapidly spread. For this reason, the position of the mainframe system was greatly weakened.

Unlike the mainframe system, the open system uses an opened interface without being dependent on the exclusive technology and program of a specific company, and thus is connected to a different type of computers and is capable of data migration to/from the different type of computer. For example, the UNIX and the like may be one of the open system.

Recently, there is an attempt to overall reestablish the mainframe system into the open system. However, this task causes a risk, and requires the high cost, many personnel, and much time.

To overcome such limitations, a rehosting solution has been newly proposed. Rehosting is an advanced IT system implementation strategy that changes IT systems, which have been established and operated in a mainframe system environment, to an open environment without redeveloping an application and enables the changed IT systems to be reused. Rehosting allows saving the initial cost and time that are expended in overall redevelopment, and minimize a risk by maximally using the existing resources, thus enabling the expectation of various positive effects.

In order to change an application program and data, which have been managed by the mainframe system, to the open system, there needs a fast and efficient data migration method that minimizes the manual requirement by sufficiently understanding the characteristics and concepts of data resources in the mainframe system. A hierarchical database which is mainly used in the mainframe system is a database in which data are managed in a tree structure having a high-low dependent hierarchy relationship. For example, IMS/DB available from IBM Corporation and ADM/DB available from Hitachi Ltd., which were commercialized in the 1970s, may be ones of the hierarchical databases.

Unlike a relational database which is presently used in most companies, in the hierarchical database, it is required to know the data structure of the hierarchical database for extracting data from the hierarchical database. However, the configuration and design of the hierarchical database are complicated and therefore, the support of highly-skilled data processing personnel is necessary.

Moreover, unlike a set of general data used in the mainframe system, application programs for data unload are required to program for each database in order to extract logic-level segment data from the hierarchical database, or it is required to use an unload utility which fundamentally is supported by the database of the mainframe system. Herein, a term of segment is a logical access unit to the hierarchical database, is configured with one or more fields, and has a concept similar to the table of the relational database.

When an application program for unload is programmed for each database, data may be extracted in a desired format, but personnel and time are expended in programming the application program for unload. For data which are downloaded with an unload utility which is supported by the database of the mainframe system, layout information on a file storage structure is not opened, and thus, the open system cannot immediately use or process the downloaded data.

In addition, the mainframe system and the open system use different code systems, and thus, if a separate code system conversion is not performed, the rehosting solution of the open system cannot use data of the mainframe system as-is.

### SUMMARY OF THE INVENTION

In view of the above, the present invention provides a data migration method and apparatus that load data of a hierarchical database, managed by a mainframe system, into a rehosting solution hierarchical database of an open system.

In accordance with an aspect of the present invention, there is provided an apparatus for migrating data from a database of a mainframe system to a rehosting solution database of an open system. The apparatus includes: an unload data set conversion module configured to convert an unload data set, unloaded from the database of the mainframe system, into load files having standard format; a schema information generation module configured to generate a schema information file, wherein the schema information file has conversion rules by segment and field necessary for code system conversion of segment data in the load files having standard format; a code system conversion module configured to convert, the load files having standard format into load files having a code system of the open system with reference to the schema information file; and a data load module configured to sequentially read segment data in the code-converted load files, and load the segment data into the rehosting solution database.

In an exemplary embodiment, the unload data set conversion module is configured to analyze the unload data set to remove meta information from the unload data set on the basis of a DBD generation sentence; extract an ID of segments and data of the segment, wherein the DED generation sentence defines a hierarchical structure of fields and a segment structure of the database; and generate the standard format of load file with the extracted ID and data.

In an exemplary embodiment, the unload data set conversion module is configured to convert a record length of the respective segments in conformity with a segment having a longest record length in the load files having standard format.

In an exemplary embodiment, the schema information generation module configured to generate schema information with reference to the DBD generation sentence and a segment copybook and the segment copybook describing a type and length of fields in segments of the database, wherein the schema information has conversion rules by segment and field necessary for code system conversion of fields in the load files having standard format.

In an exemplary embodiment, the load files having standard format conform an EBCDIC code system, and the code system conversion module is configured to convert load files, having the EBCDIC code system, into load files having an ACSII code system according to conversion rules by field of the segment on the basis of the schema information.

In an exemplary embodiment, the data load module is configured to analyze the DBD generation sentence to sequentially read segment data in the code-converted file; and load the segment data into the database of the open system.

In an exemplary embodiment, the database of the mainframe system and the database of the open system include a hierarchical database.

In accordance with another aspect of the present invention, there is provided a method of migrating data from a database of a mainframe system to a rehosting solution database of an open system. The method includes: converting an unload data set, unloaded from the database of the mainframe system, into load files having standard format; generating schema information having conversion rules by segment and field necessary for code system conversion of segment data in the load files having standard format; converting the load files having standard format into load files having a code system of the open system with reference to the schema information; and sequentially reading segment data in the code-converted load files, thereby loading the segment data into the rehosting solution database.

In an exemplary embodiment, the conversion of an unload data set includes: analyzing the unload data set on the basis of a DBD generation sentence that defines a hierarchical structure of fields and a segment structure of the database; removing meta information from the unload data set to extract IDs of segments and data of the segments; and generating the load files having standard format based on the extracted IDs and data.

In an exemplary embodiment, the conversion of an unload data set further includes: defining a length of a segment, having a longest record length in the standard format of load file, as a fixed length; and converting a record length of the respective segments according to the fixed length.

In an exemplary embodiment, the generation of the schema information includes generating schema information with reference to the DBD generation sentence and a copybook, and the schema information has conversion rules by segment and field necessary for code system conversion of fields in the standard format of load file; and the segment copybook describes a type and length of fields in segments of the database.

In an exemplary embodiment, the conversion of the load files having standard format includes converting the load files having standard format into the code-converted load files having a code system used in the open system, according to types by field of the segment on the basis of the schema information. The load files having standard format conform an EBCDIC code system, and the code-converted load files have an ACSII code system.

In an exemplary embodiment, the loading of the segment data includes: analyzing the DBD generation sentence to sequentially read segment data in the code-converted files; and sequentially loading the sequentially-read segment data into the rehosting solution database of the open system.

### BRIEF DESCRIPTION OF THE DRAWINGS

The above and other objects and features of the present invention will become apparent from the following description of embodiments given in conjunction with the accompanying drawings, in which:

FIG. 1 illustrates a block diagram of an apparatus for data migration from a hierarchical database of a mainframe system to a rehosting solution hierarchical database of an open system, in accordance with an embodiment of the present invention;

FIG. 2 illustrates an exemplary diagram for describing input/output resources employed in the apparatus for data migration from the hierarchical database of the mainframe system to the rehosting solution hierarchical database of the open system, in accordance with an embodiment of the present invention; and

FIG. 3 is a flowchart illustrating a method of migrating data from the hierarchical database of the mainframe system to the rehosting solution hierarchical database of the open system, in accordance with an embodiment of the present invention.

### DETAILED DESCRIPTION OF THE EMBODIMENTS

Hereinafter, embodiments of the present invention will be described in detail with reference to the accompanying drawings so that they can be readily implemented by those skilled in the art.

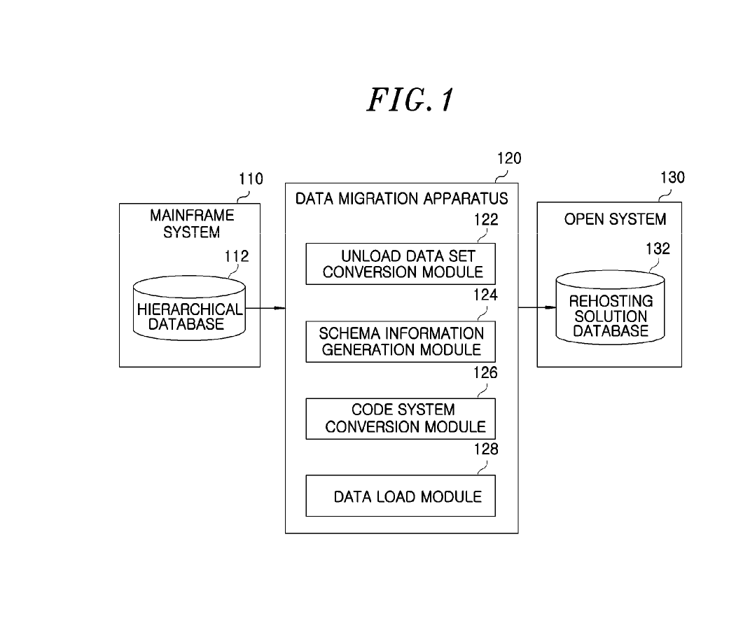

FIG. 1 illustrates a block diagram of an apparatus for data migration from a hierarchical database of a mainframe system to a rehosting solution hierarchical database of an open system, in accordance with an embodiment of the present invention.

As illustrated in FIG. 1, a mainframe system 110 includes a hierarchical database 112 built therein. An open system 130 includes a rehosting solution hierarchical database 132.

A data migration apparatus 120 between the mainframe system 110 and the open system 130 includes an unload data set conversion module 122, a schema information generation module 124, a code system conversion module 126, and a data load module 128.

Generally, a mainframe system downloads segment data of a database and stores the segment data as a separate sequential data set, in order to use the data set for temporary archiving based on the reconfiguration of a database or use the data set as backup data for an operation of recovering a system error. Fundamentally, in a mainframe system level, an unload utility is provided for storing data in a database as a sequential data set. The data set, which is unloaded from the database of the mainframe system with the unload utility, is configured in an extended binary coded decimal interchange (EBCDIC) code system.

Moreover, to generate the hierarchical database 112, the mainframe system 110 defines description information on physical definitions of segments configuring the database 112, a high-low dependent relationship between the segments, a field configuring each of the segments, a field type, and a field length, in a database description (DBD) generation sentence. Also, an application program using the hierarchical database 110 generally defines and uses a segment copybook that describes a type and length of a field in the same type as a field configuration of a segment of a database. Generally, in the COBOL application program, the segment copybook is a set of variables that are defined for inputting/outputting data of a database.

The unload data set conversion module 122 of the data migration apparatus 120 executes an unload utility to sequentially unload data from the database 122 of the mainframe system 110, in a preparation procedure of data migration. In a case where the data migration apparatus 120 is disposed at a position far away from the mainframe system 110, an acquired unload data set, for example, may be transmitted to the data migration apparatus 120 with FTP.

The unload data set conversion module 122 analyzes an unload data set with reference to a DBD generation sentence of the mainframe system, removes meta information included in the unload data set, and extracts identifiers (IDs) of segments and data of the segments. The extracted ID and data of each segment are reconfigured into a load file in standard format which is easy to convert the segment into a code system suitable for the open system 130. The load files having standard format are supplied to the code system conversion module 126. Herein, the standard format denotes a specific format that is defined in a rehosting solution.

The schema information generation module 124 generates a schema information file necessary for reference when converting the unload files in standard format into files in conformity with a code system which is used in the open system 130. In more detail, the load files having standard format generated by the unload data set conversion module 122 still has the EBCDIC code system which is used in the mainframe system 110. Also, data of segments configuring the hierarchical database 112 are mixedly loaded in the load files having standard format. Therefore, the schema information generation module 124 separates layout information of fields configuring the respective segments to generate a schema information file defining a conversion rule of fields and a segment, by using the DBD generation sentence and the segment copybook. The schema information includes a name of each segment and names, types, and lengths of fields configuring each segment. The schema information file is supplied from the code system conversion module 126.

The code system conversion module 126 converts the load files having standard format, having the EBCDIC code system, into the ASCII code system pursuant to a field type of each segment, on the basis of the schema information file. In other words, segment data has various letter sets such as 2-byte letter, packed decimal, and zoned decimal mixed therein according to a field type, and thus, is needed to be subjected to, instead of simple batch code conversion on a basis of record-unit, code conversion on a basis of field-unit. Therefore, the code system conversion module 126 code-converts the load files having standard format with reference to the schema information file defining conversion rules by field, for performing code-unit conversion on the segment data. The code-converted load file generated by the code system conversion module 126 is supplied to the data load module 128.

The data load module 128 sequentially reads the load files, having the ASCII code system, from the code system conversion module 126 and sequentially loads the read data into the hierarchical database 132 provided by the rehosting solution established in the open system 130. In this case, the data load module 128 refers to information of a DBD generation sentence corresponding to the database 112 to be a load target, for processing a logical storage structure of data in the same format as that of the hierarchical database 112 of the mainframe system 110.

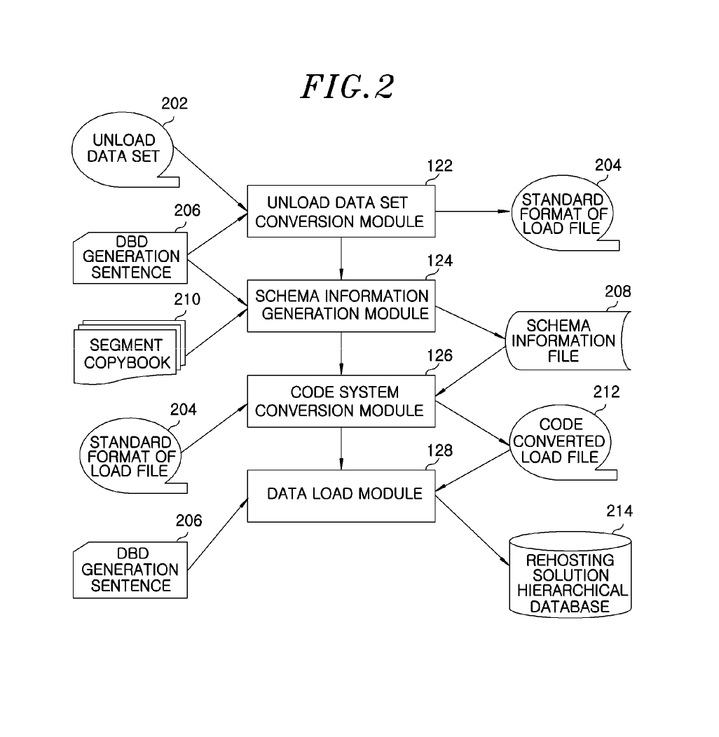

FIG. 2 illustrates a diagram for describing resources inputted/outputted to/from respective modules of the data migration apparatus 120 of FIG. 1. A data migration operation will be described below on resources inputted/outputted to/from respective modules of the data migration apparatus 120 in FIG. 2.

The unload data set conversion module 122 executes the unload utility to unload an unload data set 202 from the hierarchical database 112, and utilizes the unloaded data set 202 and a DBD generation sentence 206, which defines a segment structure of the hierarchical database 112, as its inputs. In more detail, the unload data set conversion module 122 analyzes the unload data set 202 of the hierarchical database 112 on the basis of information on a segment and fields described in the DED generation sentence 206, and removes a trailer and a header including meta information from the unload data set 202 to extract only pure data of the segment. Also, the unload data set conversion module 122 sets a length of a segment, having the longest record length, as a reference length so as to enable the easy load of data into the hierarchical database 132 of the open system 130, and converts segments of the unload data set 202 into a file having a fixed length suitable for the reference length, thereby generating a load file 204 having standard format.

The schema information generation module 124 uses the DED generation sentence 206 describing a segment structure and a segment copybook 210 describing types and lengths of fields configuring a segment as its inputs. The schema information generation module 124 utilizes the DBD generation sentence 206 and the segment copybook 210 for generating rules for code system conversions by field and generates a schema information file 208 that defines conversion rules by segment and field.

The code system conversion module 126 receives the load files having standard format 204 as an input from the unload data set conversion module 122 and receives a schema information file 208 as an input from the schema information generation module 124. The code system conversion module 126 sequentially reads the load files having standard format 204, and converts an EBCDIC code of the load files having standard format 204 into the ASCII code based on conversion rules by field of the schema information file 208. In case where the load files having standard format 204 has a number type commonly used in the mainframe system 110, the code system conversion module 126 may convert a number type of the load files 204 having standard format into a number type recognizable by the open system 130. Accordingly, the code system conversion module 126 generates the load files 204 having standard format into a code-converted load files 212 available by the rehosting solution of the open system 130.

The data load module 128 receives the DBD generation sentence 206 and the code-converted load file 212 from the code system conversion module 124. The data load module 128 sequentially reads the code-converted load files 212, namely, ASCII code files, and loads data of the load files 212 into the rehosting solution hierarchical database 132 according to a segment hierarchy sequence on a basis of the DBD generation sentence 206 relevant thereto. After loading the data, if necessary, by sequentially checking the rehosting solution hierarchical database 132, data may be checked in the same hierarchy sequence as that of the hierarchical database 112 of the mainframe system 110.

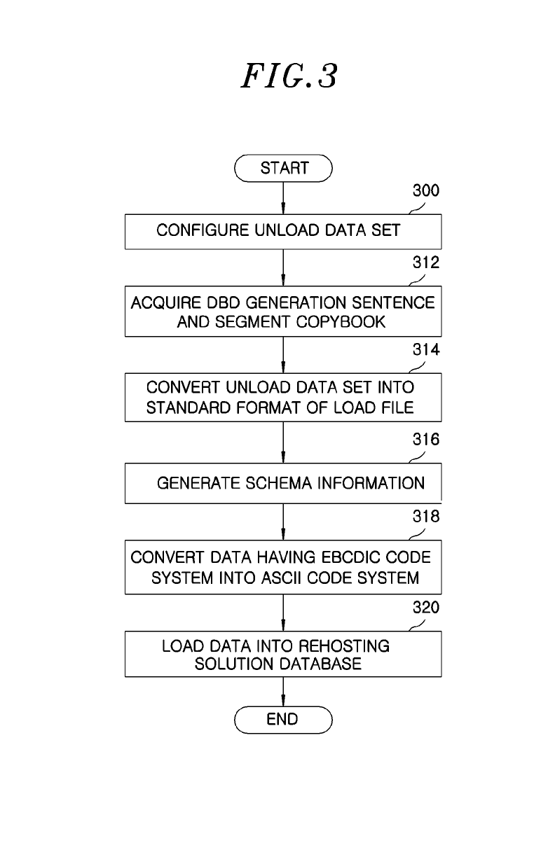

FIG. 3 is a flowchart illustrating a method of migrating data from the hierarchical database of the mainframe system to the rehosting solution hierarchical database of the open system, in accordance with an embodiment of the present invention.

In operation 310 that is a first operation among operations of migrating the data of the hierarchical database 112, the data migration apparatus executes the unload utility to sequentially unload data building the hierarchical database 112, thereby configuring the unload data set 202.

In operation 312, subsequently, the data migration apparatus acquires the DBD generation sentence 206 defining the hierarchical database 112 of the mainframe system 110 and the segment copybook 210 describing the types and lengths of fields in segments of the hierarchical database 112, and the code system conversion module 126 converts a source of each of the DBD generation sentence 206 and segment copybook 210 into a record-unit code so as to enable reference in a next operation. The code conversion is for reference when the unload data set 202 is code-converted in a next operation.

In operation 314, the unload data set conversion module 122 analyzes the DBD generation sentence 206, removes meta information from the unload data set 202 to extract pure segment data, and converts the segment data into the standard format of load file 202 which is easy to load the segment data into the hierarchical database 132 of the open system 130.

Generally, an application program accessing a hierarchical database processes the input and output of data of segments with a segment copybook that describes types and lengths of fields configuring the segments. Thus, in operation 316, the schema information generation module 124 generates schema information including conversion rules by field of a segment which is necessary for performing a code system conversion operation on the basis of contents described in the segment copybook 210.

One hierarchical database may be configured with different segments. In this sense, data of different segments may be mixed in a data set unloaded from the mainframe system 110. Accordingly, it should be noted that a conversion format of code system differs from segments and thus these segments are required to be processed with their corresponding conversion formats.

In operation 318, the code system conversion module 126 performs a code system conversion on the load files 204 having the EBCDIC code system with reference to the schema information file 208, thereby converting the standard format of load file 204 into the files 212 having the ASCII code system. During this file conversion, a mapping process of a field type and a field length is performed using conversion rules defined by segment and field of the schema information file 208.

In operation 320, the data load module 128 loads the load files 212, converted into the ASCII code system, into the rehosting solution hierarchical database 132. At this point, the data load module 128 analyzes the DED generation sentence of the hierarchical database 112 to sequentially read the load files 212 having the ASCII code system, and performs appropriate load processing in view of a logical storage structure between different segments.

As described above, according to the data migration apparatus and method of the present invention, even though the data structure or configuration of the hierarchical database of the mainframe system is not known well, segment data of the hierarchical database can be easily and quickly migrated to the open system with matchability being maintained and used. Also, the present invention can solve problems which are caused by the different code systems of the mainframe system and open system, and the open system can perform data processing equal to an operation result on the hierarchical database of the mainframe system, thus enabling the existing application program of the mainframe system to be reused as-is.

While the invention has been shown and described with respect to the embodiments, the present invention is not limited thereto, it will be understood by those skilled in the art that various changes and modifications may be made without departing from the scope of the invention as defined in the following claims.

What is claimed is:

1. An apparatus for migrating data from a database of a mainframe system to a rehosting solution database of an open system, including:
an unload data set conversion module configured to convert, an unload data set, unloaded from the database of the mainframe system, into load files having standard format;
a schema information generation module configured to generate a schema information file, wherein the schema information file has conversion rules by segment and field necessary for code system conversion of segment data in the load files having standard format;
a code system conversion module configured to convert the load files having standard format into load files with reference to the schema information file, wherein the load files has a code system of the open system; and
a data load module configured to sequentially read segment data in the code-converted load files, and load the segment data into the rehosting solution database.

2. The apparatus of claim 1, wherein the unload data set conversion module is configured to:
analyze the unload data set to remove meta information from the unload data set on the basis of a database description (DBD) generation sentence;
extract an ID of segments and data of the segment, wherein the DBD generation sentence defines a hierarchical structure of fields and a segment structure of the database; and
generate the standard format of load file with the extracted ID and data.

3. The apparatus of claim 2, wherein the unload data set conversion module is configured to convert a record length of the respective segments in conformity with a segment having a longest record length in the load files having standard format.

4. The apparatus of claim 2, wherein the schema information generation module as configured to generate schema information with reference to the DBD generation sentence and a segment copybook,
wherein the schema information has conversion rules by segment and field necessary for code system conversion of fields in the load files having standard format, and the segment copybook describes a type and length of fields in segments of the database.

5. The apparatus of claim 1, wherein the load files having standard format conform an extended binary coded decimal interchange (EBCDIC) code system, and
wherein the code system conversion module is configured to convert load files, having the EBCDIC code system, into load files having an ACSII code system according to conversion rules by field of the segment on the basis of the schema information.

6. The apparatus of claim 2, wherein the data load module is configured to analyze the DBD generation sentence to sequentially read segment data in the code-converted file; and load the segment data into the database of the open system.

7. The apparatus of claim 6, wherein the database of the mainframe system and the database of the open system comprise a hierarchical database.

8. A method of migrating data from a database of a mainframe system to a rehosting solution database of an open system, including:
converting an unload data set, unloaded from the database of the mainframe system, into a load files having standard format;
generating schema information having conversion rules by segment and field necessary for code system conversion of segment data in the load files having standard format;
converting the load files having standard format into load files having a code system of the open system with reference to the schema information; and
sequentially reading segment data in the code-converted load files, thereby loading the segment data into the rehosting solution database.

9. The method of claim 8, wherein said converting an unload data set comprises:
analyzing the unload data set on the basis of a database description (DED) generation sentence that defines a hierarchical structure of fields and a segment structure of the database;
removing meta information from the unload data set to extract IDs of segments and data of the segments; and
generating the load files having standard format based on the extracted IDs and data.

10. The method of claim 9, wherein said converting an unload data set further comprises:
defining a length of a segment, having a longest record length in the standard format of load file, as a fixed length; and
converting a record length of the respective segments according to the fixed length.

11. The method of claim 8, wherein said generating the schema information comprises generating schema information with reference to the DBD generation sentence and a copybook,
wherein the schema information has conversion rules by segment and field necessary for code system conversion of fields in the standard format of load file; and the segment copybook describes a type and length of fields in segments of the database.

12. The method of claim 8, wherein said converting the load files having standard format comprises converting the load files having standard format into the code-converted load files having a code system used in the open system, according to types by field of the segment on the basis of the schema information, and
the load files having standard format conform an extended binary coded decimal interchange (EBCDIC) code system, and the code-converted load files have an ACSII code system.

13. The method of claim 8, wherein said loading the segment data comprises:
analyzing the DBD generation sentence to sequentially read segment data in the code-converted files; and
sequentially loading the sequentially-read segment data into the rehosting solution database of the open system.
